(19) United States
(12) Patent Application Publication
(10) Pub. No.: US 2011/0146801 A1
(43) Pub. Date: Jun. 23, 2011

(54) INJECTION ADDITIVES INTO CLOSED SYSTEMS

(75) Inventors: John S. Kosco, Tecumseh, MI (US); John R. Burke, Warren, MI (US); Barry J. Harrison, Davisburg, MI (US)

(73) Assignee: Bright Solutions International LLC, Troy, MI (US)

(21) Appl. No.: 12/997,606

(22) PCT Filed: Jun. 11, 2009
(86) PCT No.: PCT/US09/46985

§ 371 Date: Mar. 9, 2011

Related U.S. Application Data
(60) Provisional application No. 61/074,354, filed on Jun. 20, 2008.

(51) Int. Cl. F15D 1/00

(52) U.S. Cl. 137/1

(57) ABSTRACT

A method for introducing additives into a closed system though a high pressure side service port is disclosed. In a first example, a method of introducing an additive into a closed system is disclosed comprising the steps of connecting a fluid flow path with the high pressure side service port of a closed system and transporting the additive from a fluid reservoir through the fluid flow path into the high pressure side service port of the system. The method may further comprise purging the closed system prior to introducing the additive into the system.

### CLAIM FOR PRIORITY This application claims priority to U.S. Provisional Patent Application No. 61/074,354, filed on Jun. 20, 2008, which is hereby incorporated by reference in its entirety.

### TECHNICAL FIELD

This invention relates to a method for introducing additives into closed systems though a high pressure side service port.

### BACKGROUND

Introduction of additives into a closed system can require devices and techniques to be developed that optimize the efficiency, neatness and cleanliness of the introduction. One method in which these issues can be important is in leak detection methods developed to analyze fluid systems, such as climate control systems, such as heating, cooling, ventilating, air conditioning and refrigeration or HVAC-R (heating, ventilation and air conditioning and refrigeration) systems, using dyes.

### SUMMARY

The practice of introducing additives for closed systems through the low pressure side service port or adding the additive (in the case of dye) directly into the closed system when the pipe work/components are not fully assembled or when the components are fully assembled, turns out not to be the most efficient approach. Lubricant circulation from the low side in most systems is very low, which diminishes the circulation of additives in the system, causing the additive to tend to stay in the oil collected at the compressor rather than circulate around the system. The low circulation means that the additive does not get around the system quickly or in such volume to carry out the function for which it has been designed. Advantageously, introducing the additives through the high pressure side service port results in rapid and maximized circulation of the additive through the system, particularly in comparison to introduction through the low pressure side service port.

Further, if the additive is injected at the low side, there can be a risk of flooding the compressor with a large volume, or “slug”, of additive as the low-side port is located just before the compressor. By injecting the additive at the high-side port, this possibility of catastrophic failure is reduced or possibly avoided. Another advantage for injecting at the high side is that the system components that leak are usually located between the high-side port and the compressor. So the injection near the location where the additive is required is advantageous versus injection at a point far from the location where it is required. Possible major leak sites include the heat exchangers (condensers and evaporators) and these are situated between the high-side port and the compressor. Hence for leak detection dyes and for leak stop additives, injection at the high-side can be especially beneficial.

Similarly, some performance enhancers appear to work by removing an old layer of lubricant from the inside walls of a heat exchanger, more particularly the evaporator. This displacement of “old oil” of a certain thickness by the new additive “film” (generally asserted to be one molecule thick and hence much thinner than the “old oil” layer) is said to enhance heat exchange and thereby system performance. The fact that these performance enhancing products are to be injected at the high-side port proximate to their location of use can mean that more of the additive is likely to reach its intended target zone and in a shorter time frame versus injection at the low-side port which is remote from the intended target zone.

In one aspect, the method of introducing an additive into a closed system includes connecting a fluid flow path with the high pressure side service port of a closed system, and transporting the additive from a fluid reservoir through the fluid flow path into the high pressure side service port of the system. The method can further include purging the closed system prior to introducing the additive into the system. The method can also include circulating the additive through the system before entering a compressor. The method can include disconnecting the fluid path from the high-side port after the additive has entered the closed system. The closed system can be a climate control system. The climate control system can be an air conditioning system. The climate control system can be a refrigeration system. The climate control system can be stationary. The climate control system can be mobile. The additive can include oil, a leak detection dye, a lubricant, a leak stop additive, an acid neutralizer a moisture scavenger or a performance-enhancing product or a combination of two or more of the additives. The liquid reservoir can further include a vessel, which can be a canister, containing the additive.

In another aspect, a method of introducing a leak detection dye in a closed system includes connecting a fluid flow path with the high pressure side service port of a closed system and transporting the leak detection dye from a fluid reservoir through the fluid flow path into the high pressure side service port of the system. The closed system can be a climate control system or an air conditioning system. The climate control system can be a refrigeration system. The closed system can be a hermetic system. The method can further include transporting leak stop additives from the fluid reservoir through the fluid flow path into the high pressure side service port of the system.

In another aspect, a method of enhancing the performance of a closed system can include connecting a fluid flow path with the high pressure side service port of a closed system and transporting a performance-enhancing product from a fluid reservoir through the fluid flow path into the high pressure side service port of the system. The method can further include circulating the performance-enhancing product through the system before entering a compressor. The closed system can be a heating, ventilation and air conditioning and refrigeration (HVAC-R) system.

In one aspect, a method of introducing a leak stop additive in a closed system can include connecting a fluid flow path with the high pressure side service port of a closed system and transporting the leak stop additive from a fluid reservoir through the fluid flow path into the high pressure side service port of the system. The closed system can be a climate control system. The climate control system can be an air conditioning system.

In a further aspect, a method of scavenging the moisture out of a closed system can include connecting a fluid flow path with the high pressure side service port of a closed system and transporting a moisture scavenger from a fluid reservoir through the fluid flow path into the high pressure side service port of the system. The method can further include circulating the moisture scavenger throughout the system. The closed system can be a climate control system. The climate control system can be an air conditioning system.

In another aspect, a method of detecting or stopping a leak in a closed system can include connecting a fluid flow path with the high pressure side service port of a closed system and transporting a leak detection dye and a leak stop additive from a fluid reservoir through the fluid flow path into the high pressure side service port of the system. The method can further include circulating the leak detection dye and the leak stop additive throughout the system. The closed system can be a climate control system. The climate control system can be an air conditioning system.

The details of one or more embodiments are set forth in the accompanying drawings and the description below. Other features, objects, and advantages of the invention will be apparent from the description and drawings, and from the claims.

### DESCRIPTION OF DRAWINGS

FIG. 1 is a schematic diagram illustrating a method of introducing additives into the high pressure side service port of a closed, pressurized system.

FIGS. 2A and B are schematic diagrams illustrating the flow of additives through a refrigerant source to the high pressure side service port of a closed, pressurized system.

### DETAILED DESCRIPTION

To improve the circulation of additives in a closed system, an apparatus for injecting an additive into a closed pressurized system can be connected to a high pressure side service port of the system. Introduction of additives into the high pressure side service port ensures that the additive is circulated in an efficient manner through the entire system and will not remain in the oil bath within the compressor. The system can be a climate control system such as an air conditioning or heating, ventilating, air conditioning system or refrigeration system (HVAC-R). The additive can be oil, leak detection dye, a formulation for sealing leaks, a moisture scavenger, an acid neutralizer or performance-enhancing product, for example, a substance that prolongs the life of the system, a system component, or an assembly of system components and/or one that increases the efficient operations of the system. The additive can be any substance suitable for use in a climate control system. By introducing the additive into the high pressure side service port, the refrigerant/lubricant flow can then carry the additive through the system before entering the compressor.

The method of introducing an additive into the closed pressurized system at the high pressure side service port of the system can be carried out in a variety of ways. In one embodiment, the method can include introducing the additive via a fluid flow path. The fluid reservoir can include an injection device to inject dye or lubricant into the system. Such an injection device can include for example, the device or apparatus described in U.S. Pat. Nos. 6,196,016, 6,442,958, and 6,308,528, each of which is incorporated by reference in its entirety. The fluid flow path can flow from a fluid reservoir into the high pressure side service port of the system. The fluid flow path can also include a hose and an outlet of the injection device. The method can further include purging the closed system prior to introducing the additive into the system. Purging can include pulling a vacuum on a closed system.

The injection device can have a chamber that is refillable with a source of additive or pre-filled with additive. The source of the additive can be in the form of a vessel such as a pressurized canister, a canister under vacuum or normal atmospheric pressure, a hose, a container, a bottle, a syringe, a cartridge, a capsule, a mist infuser, a bag, or any other fluid transfer or storage apparatus that can be included in or connected to the injection device. The device can allow a controlled, variable amount of additive to be repeatedly injected into the high pressure side service port of the system without opening the device. When the device is filled with fluid, most air left in the injection device can be purged with an inert gas such as nitrogen.

The climate control system can be purged of fluids or gas prior to injecting dye, leak stop additive, moisture scavenger, acid neutralizer or lubricant into the system. The purging process can include pulling a vacuum on the system. Moisture can be removed in the purging process. The system can also be flushed prior to injecting additives such dye or lubricant into the system.

Other injection devices can include flow chamber systems and syringe-type systems for introducing additives into the system. A flow-chamber system generally has a reservoir into which a leak detection dye solution is poured or a dye capsule is loaded and sealed. A carrier is then passed through the reservoir to transport the dye into the system. A syringe-type system generally has a chamber that is loaded by pouring the leak detection dye into the chamber or is preloaded by the manufacturer. The dye is then forced from the chamber into the closed system. The device is then disconnected from the port. Other injector systems include mist diffusers.

Materials used for components should be compatible with the additive to be inserted in the system and, where applicable, with the gas in the system. This is particularly true of o-rings, hoses and syringe materials. The components can be of dimensions sufficient to make the method efficient. The components can be of sufficient strength to handle the pressures associated with the injection methods.

In one embodiment, a leak detection dye composition can be introduced into a climate control system through the high pressure side service port of the system. The climate control system can be a stationary system, a window air conditioning system a portable, residential, or commercial air conditioning system or any other hermetic system that employs a refrigerant and a lubricant. After the leak detection dye has been loaded into the climate control system, the system can be operated to circulate the leak detection dye composition. The circulating refrigerant can disperse the leak detection dye throughout the system or to parts thereof.

Typically the dye content of the system can be below about 0.1 percent. After the dye has been allowed to circulate within the system, the system joints, components, or attachments can be examined with a light source having a wavelength from 190 nanometers to 700 nanometers. The presence of a leak can be determined by a colored visual indication such as fluorescence or other light emission that can be detected after excitation with the light from the light source. Alternatively, if the leak detection composition includes a visible leak detection dye, visible to the unaided eye, the presence of the leak can be determined by visual inspection of the climate control system.

The leak detection dye composition supply can be stored, transported or otherwise contained in the form of a pressurized canister, a hose, a container, or any other fluid transfer or storage apparatus that can be connected to a high pressure side service port. The leak detection composition can be a combination of a refrigerant, a lubricant, and a dye concentrate. The refrigerant can include chlorofluorocarbons, hydrochlorofluorocarbons, hydrofluorocarbons, carbon dioxide, ammonia, halogenated or ether derivatives of methane or ethane, or halogenated ether or cyclic derivatives of propane, butane, or other hydrocarbons. Examples of a refrigerant include 1,1,1,2 tetrafluoroethane (R-134a, Allied Signal, Morristown, N.J.) and dichlorodifluoromethane (R-12, DuPont, Wilmington, Del.), carbon dioxide, or next generation refrigerants. The lubricant can include polyalkylene glycols, polyolesters, mineral oils, polyvinyl ethers, alkylbenzenes, polyalpha olefins or other synthetic lubricating materials. The dye concentrate can include leak detection dye such as a fluorescent dye. The fluorescent dye can include a naphthalimide dye, a perylene dye, a coumarin dye, a thioxane dye, a fluorescein dye, or a derivative thereof or other dye compatible with a climate control systems. The fluorescent dye can be liquid or solid, such as a powder. Examples of suitable dyes include liquid dyes, for example, STAY- BRITE BSL 714 (Bright Solutions, Troy Mich.), DAY GLOW TRY-33 or TRY-53 (Day Glow Color Corp, Cleveland, Ohio), R-12 Dye STAY-BRITE BSL713 (part B713012), or R-134a Dye STAY-BRITE BSL712 (part B712012) or other dyes.

The leak detection dye composition can include, for example, a first weight amount of the dye concentrate and a second weight amount of the refrigerant. The first weight amount can be greater than the second weight amount. In other embodiments the leak detection dye composition can include, for example, a first weight amount of dye concentrate, a second weight amount of lubricant and a third weight amount of refrigerant. The first and second amounts together can be greater than the third amount. See, for example, U.S. Pat. No. 6,183,663, which is incorporated by reference in its entirety.

The performance-enhancing product can extend the lifetime of the system or give new life to bearings, seals, and all compressor parts, increase cooling capacity, quiet compressor noise, or decrease fuel consumption by reducing friction, thereby improving the compressor's mechanical efficiency and lowering its power consumption. The product may have the effect of reducing the temperature that comes out of the vents. The product can coat the parts better than existing lubricants resulting in longer life for the compressor and certain components.

A moisture scavenger can include organometalloid and/or organometallic compounds as described in U.S. Pat. No. 5,882,543, which is incorporated by reference in its entirety. Other methods of removing water are described in U.S. Pat. Nos. 4,304,805, 4,331,722, 4,379,067, 4,442,015 and 4,508,631 of Packo et al. which teaches the use of silicon-containing compounds including certain mercaptosilanes, acyloxysilanes, aminosilanes, and alkoxysilanes in conjunction with acetic anhydride or aminosilanes. The moisture scavenger can have the ability to react with water and thereby sequester it or otherwise remove it from the system.

In one embodiment, a leak stop additive (such as Bright Solutions International LLC product code B47105) can be introduced into a hermetic system by connecting a fluid flow path with the high pressure side service port of the system, transporting the additive from a fluid reservoir through the fluid flow path into the high pressure side service port of the system, circulating the additive through the system and sealing a leak at the point of emission of the leak stop additive. Examples of leak stop additives are described in U.S. Pat. No. 5,882,543 entitled “Compositions and methods for dehydrating, passivating and sealing systems,” which is incorporated by reference in its entirety.

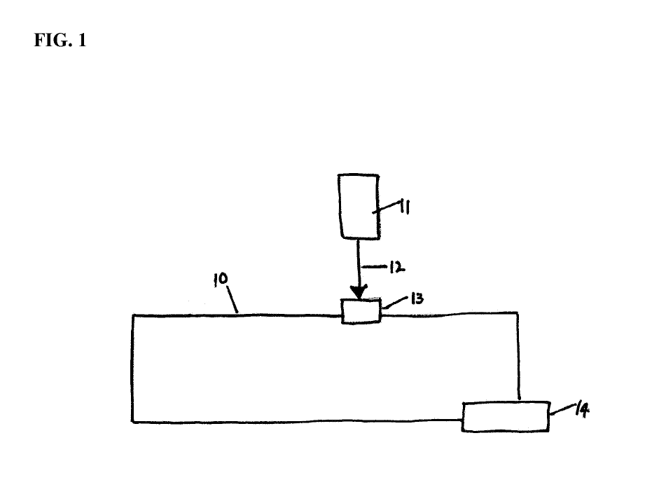

With reference to FIG. 1, an additive is introduced into a closed pressurized system 10. Injection device 11, containing the additive, is connected to fluid flow path 12. The additive flows through a fluid flow path 12 to the high pressure side service port of the system 13. The additive then circulates through the system before entering a compressor 14. The system depicted in FIG. 1. can be used to introduce additives into a closed pressurized system such as a climate control system such as an air conditioning or heating, ventilating, air conditioning, or refrigeration system (HVAC-R).

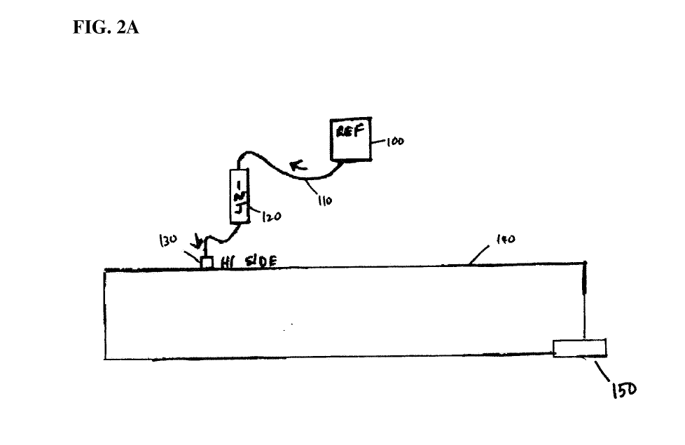

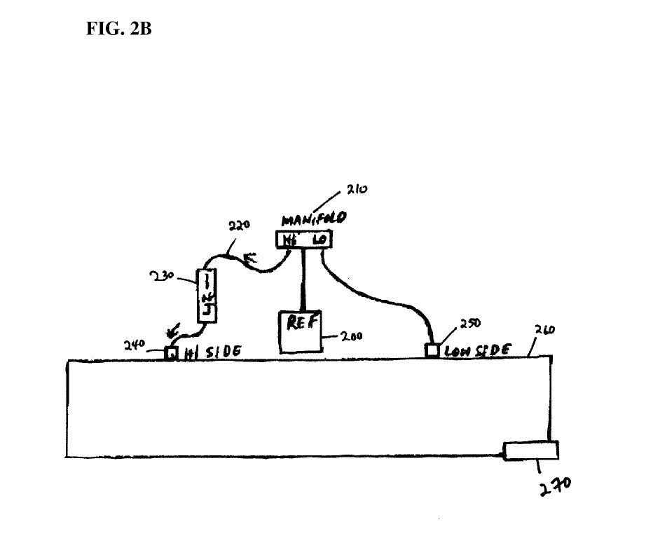

With reference to FIG. 2A, .the refrigerant is contained in refrigerant source 100. The additive is contained in the injector 120. The refrigerant flows from the refrigerant source 100, such as a refrigerant cylinder, through a fluid flow path 110 and continues flowing through injector 120. By flowing through injector 120, the flow causes the additive in injector 120 to flow out of the injector 120 through a continued flow path (not marked) into the high side port 130 of the system 140. The additive then circulates through the system before entering compressor 150.

With reference to FIG. 2B, an additive can be introduced from a refrigerant source 200. The additive can flow from the refrigerant source 200 to a standard manifold gauge set 210 (showing HI (high) and LO (low) outlets) to a reservoir 230 utilized for the injection of the additive and enter the high pressure side service port 240 of the system 260. The additive then circulates through the system before entering a compressor 270. Other embodiments are within the claims.

1. A method of introducing an additive into a closed system comprising:
connecting a fluid flow path with the high pressure side service port of a closed system; and
transporting the additive from a fluid reservoir through the fluid flow path into the high pressure side service port of the system.

2. The method of claim 1, further comprising purging the closed system prior to introducing the additive into the system.

3. The method of claim 1, further comprising circulating the additive through the system before entering a compressor.

4. The method of claim 1, wherein the closed system is a climate control system or a hermetic system.

5. The method of claim 4, wherein the climate control system is an air conditioning system or a refrigeration system.

6. (canceled)

7. The method of claim 1, wherein the liquid reservoir further includes a vessel containing the additive.

8. The method of claim 1, wherein the additive includes a leak detection dye, a lubricant, a leak stop additive, a moisture scavenger, oil, an acid neutralizer or a performance-enhancing product.

9. The method of claim 1, further comprising disconnecting the fluid flow path from the high-side service port once the additive has entered the closed system.

10. (canceled)

11. The method of claim 1, further comprising circulating a leak stop additive through the system and sealing a leak at the point of emission of the leak stop additive.

12. A method of introducing a leak detection dye in a closed system comprising:
connecting a fluid flow path with the high pressure side service port of a closed system; and
transporting the leak detection dye from a fluid reservoir through the fluid flow path into the high pressure side service port of the system.

13. The method of claim 12, wherein the closed system is a climate control system or a hermetic system.

14. The method of claim 13, wherein the climate control system is an air conditioning system or a refrigeration system.

15. (canceled)

16. (canceled)

17. The method of claim 12, further comprising transporting leak stop additives from the fluid reservoir through the fluid flow path into the high pressure side service port of the system.

18. A method of enhancing the performance of a closed system comprising:
connecting a fluid flow path with the high pressure side service port of a closed system; and
transporting a performance-enhancing product from a fluid reservoir through the fluid flow path into the high pressure side service port of the system.

19. The method of claim 18, further comprising circulating the performance-enhancing product through the system before entering a compressor.

20. The method of claim 18, wherein the closed system is a heating, ventilation and air conditioning and refrigeration (HVAC-R) system.

21. A method of introducing a leak stop additive in a closed system comprising:
connecting a fluid flow path with the high pressure side service port of a closed system; and
transporting the leak stop additive from a fluid reservoir through the fluid flow path into the high pressure side service port of the system.

22. The method of claim 21, wherein the closed system is a climate control system.

23. The method of claim 22, wherein the climate control system is an air conditioning system.

24. A method of scavenging the moisture out of a closed system comprising:
connecting a fluid flow path with the high pressure side service port of a closed system; and
transporting a moisture scavenger from a fluid reservoir through the fluid flow path into the high pressure side service port of the system.

25. The method of claim 24, further comprising circulating the moisture scavenger through the system.

26. The method of claim 24, wherein the closed system is a climate control system.

27. The method of claim 26, wherein the climate control system is an air conditioning system.

28. The method of claim 1, wherein the additive includes
a leak detection dye and a leak stop additive.

29. (canceled)

30. (canceled)

31. (canceled)
